(19) United States
(12) Patent Application Publication
(10) Pub. No.: US 2026/0025282 A1
(43) Pub. Date: Jan. 22, 2026

(54) MULTI-PARTY AND MULTI-USE QUANTUM RESISTANT SIGNATURES AND KEY ESTABLISHMENT

(71) Applicant: PRIVATEGRITY CORPORATION, Encino, CA (US)

(72) Inventor: David CHAUM, Sherman Oaks, CA (US)

(21) Appl. No.: 19/347,195

(22) Filed: Oct. 1, 2025

Related U.S. Application Data
(62) Division of application No. 17/778,214, filed on May 19, 2022, now abandoned.
(60) Provisional application No. 62/938,992, filed on Nov. 22, 2019.

(51) Int. Cl. H04L 9/32

(52) U.S. Cl. CPC H04L 9/3247; H04L 9/3265

(57) ABSTRACT

A system for making digital signatures includes plural signers determining cleartext bits to sign in response to a hash of a pre-image known to the respective signer and message. Another system uses one-way functions and a plurality of authentication paths per signature. A key information distribution system uses physical media, physical media revealing means, and changing the configuration of the physical media revealing means to reveal secret indicia to observers.

### FIELD OF THE INVENTION

The present invention relates to improvements in making digital signatures, including plural signers determining cleartext bits, and using one-way functions and a plurality of authentication paths per signature, and a key information distribution system that uses physical media, physical media revealing means, and changing the configuration of the physical media revealing means to reveal secret indicia to observers.

### BACKGROUND ART

Digital communication is at the heart of almost every aspect of modern life. Throughout the expansive growth of digital communication channels and especially the Internet, the continued development of cryptographic digital signatures and encryption systems has enabled societies and economies to efficiently interact with confidence that communicated data is secure against adversaries and forgeries. Traditionally, these standardized cryptographic protocols have kept pace with the increasing capabilities of potential adversaries. Recently it is becoming more and more likely that quantum computers capable of breaking the majority of currently used cryptographic protocols will be developed.

So-called hash-based signatures are among the only known cryptographic signature schemes that are believed to be able to withstand quantum computing attacks. The known hash-based signature schemes such as WOTS+ are one time use forcing additional data structures layers to map multiple one time use public keys to a single reusable public key such as in XMSS. Because of this, public keys can only be used a finite number of times forcing signers to maintain state on used keying material, and the signatures generated generally orders of magnitude larger and slower than the signature schemes widely used today.

The potential overhead of eventually moving to secure digital communication via quantum-resistant cryptography is exacerbated in the environment of heterogeneous and untrusted decentralized networks which is growing to secure hundreds of billions of dollars in value as of 2020. In many of these networks, where nodes are owned and operated by thousands of unknown individuals across the globe, infrastructure hardware is not comparable in computing performance or communication speed and reliability to the centralized infrastructure that has supported much of the growth of the Internet. Decentralized infrastructure currently struggles to handle even the more efficient cryptographic protocols used today at scale.

A further hurdle to adopting quantum-resistant cryptography is in the establishment of quantum-resistant authentication mechanisms. Modern certificate authorities and means for establishing trusted knowledge of public keys are based on cryptography which is vulnerable to quantum computing. These typical authentication mechanisms may not be capable of bridging the gap between compromised cryptographic protocols and new, stronger standards.

### SUMMARY OF THE INVENTION

The invention provides a number of improvements in the field of digital signatures for a message, plural digital signatures using a one-way function, and systems for distribution of key information.

In one aspect, the invention is an improvement in a system for making a digital signature for a message where pre-defined subsets of a set of signers is sufficient and where each potential signer has pre-images that hash to a public key. In this improvement, each of the signers determines cleartext bits to sign in response to a hash of a pre-image known to the respective signer and the message. Preferably, the total number of cleartext bits, summed over all signers, can range from about 100 to about 1000. The size of the subsets and the length of the plaintext bit strings signed can be such that the number of exhaustive search attempts would be more the 2⁸⁰. In another embodiment, the number of bits is at least 16 and the number of signers is a majority of at least 100 parties.

A second aspect of the invention is an improvement in a system for forming plural digital signatures using one-way functions on respective plural messages, with a common public key and a common secret seed value. In this aspect, two or more authentication paths per signature are employed. In a further mode, at least one of the paths can be a series authentication path or a tree authentication path or a combination of both.

A third aspect of the invention relates to improvements in key information distribution systems. This improvement provides a system that produces, for each of plural parties, respective physical media that includes respective secret key information formed as indicia. The respective physical media for each party is provided with physical revealing means, the physical revealing means in a first physical state, so that the secret indicia is not substantially revealed to plural observers. The system then allows for changing the physical configuration of the physical revealing means, after the media is received, from the first physical state to a second physical state. With this change, the secret indicia of substantially all the plural parties becomes known to the plural observers by the change of state.

In certain cases, some subset of the observers can include the parties. The indicia can be images under substantially one-way functions and corresponding respective substantial pre-images can be shown after the images are revealed by the second physical state.

The images revealed in the second physical state can be combined by a pre-arranged algorithm to form a value that is at least substantially infeasible for proper subsets of the parties to either manipulate or learn in advance.

The indicia can be formed on the media by the respective party. Also, the party forming the indicia on the media can hide the indicia in a respective physical carrier. The party forming the indicia on media can provide the respective physical carrier to the physical revealing means under observation of the observers. The party forming the indicia on media can also provide the respective physical carrier to the physical revealing means in a particular location within a framework under observation of the observers. The carrier combined with the indicia combined with the placement in the framework can reveal an identity of the party to the observers.

The indicia can be printed on cards and the cards can be protected by substantially opaque cards layered on the card at least until they are transferred to the physical revealing means. The cards and the opaque cards can be held together by a physical carrier means, the physical revealing means comprising a framework for holding carriers without the hiding means.

Another improvement in key distribution systems relates to a system that includes a first step of forming secret keys for respective plural parties as indicia hidden from observers by respective carriers. A container is provided to accept plural contributions of carriers from each of the plural parties, with the container configured to be at least partly rearranged. After the at least partial rearrangement, the parties each receive plural carriers from the container. The system provides for provision of authentication by the respective parties of fingerprints of the keys that were contained in the carriers contributed by the respective parties.

The system can also provide cryptographic authentication by keys revealed by each party that are associated with that respective party and this authentication can include authentication by keys revealed by each party in person to other parties while observed by observers.

The content of the container can be at least partly rearranged by physically changing an orientation of the container under observation of observers

At least some of the observers can be the parties.

The system also allows substantially hiding from at least some observers correspondence between the party corresponding to at least a carrier contributed and the party receiving that carrier during the at least partly rearranging.

Another feature of the system includes a set of parties allowing a pair of parties that did not receive a common key to develop a common key by each of the set of parties providing the same secret to both members of the pair of parties. With this, at least some of the allowing set of parties can provide to the pair of parties authentication of fingerprints of the key provided that pair.

The system also includes forming of the carriers by the respective parties forming the indicia on a media layer and including additionally a substantial hiding layer. The carrier forming can include at least one party applying a scratch-off layer to the respective indicia bearing portion of the media as at least part of the hiding layer.

### BRIEF DESCRIPTION OF THE DRAWINGS

FIG. 1 is a block flow chart showing according to one embodiment showing phases for generating a multiparty signature.

FIGS. 2A-2D are block diagrams of exemplary ways to coordinate generating keying material for a multiparty signature.

FIG. 3A is a block flow chart of keying material according to one embodiment of an endorsement of a hash-based multiparty signature algorithm.

FIG. 3B is a block flow chart according to one embodiment of steps that a party member takes to generate a hash-based multiparty signature public key.

FIG. 4A is a block flow chart according to one embodiment showing steps that a signing party in a multiparty signature scheme may use to generate an endorsement on a message.

FIG. 4B is a block flow chart according to one embodiment showing steps that a party in a multiparty signature scheme may use to verify a multiparty signature.

FIG. 5 is a block flow chart according to one embodiment of keying material for a multi-use public key signature scheme with at least two authentication paths.

FIG. 6 is a tree flow chart according to one embodiment of a multi-use public key signature scheme with at least three authentication paths.

FIG. 7 is a block flow chart according to one embodiment for generating a multi-use public key.

FIG. 8 is a block flow chart according to one embodiment for generating signatures from a multi-use public key.

FIG. 9A is a block flow chart according to one embodiment for generating signature material for a second authentication path in a multi-use public key signature scheme with at least two authentication paths.

FIG. 9B is a block flow chart according to one embodiment for generating signature material for a third authentication path in a multi-use public key signature scheme with at least three authentication paths.

FIG. 10 is a block flow chart according to one embodiment for verifying signatures in a multi-use public key signature scheme with at least three authentication paths.

FIGS. 11A-J are exemplary detailed combination plan and section views of schematic and block diagrams for key establishment.

FIGS. 12A-B are exemplary detailed combination flowchart and block diagrams for key establishment.

FIGS. 13A-D are exemplary detailed combination flowchart and block diagrams for key distribution.

### DETAILED DESCRIPTION OF THE INVENTION

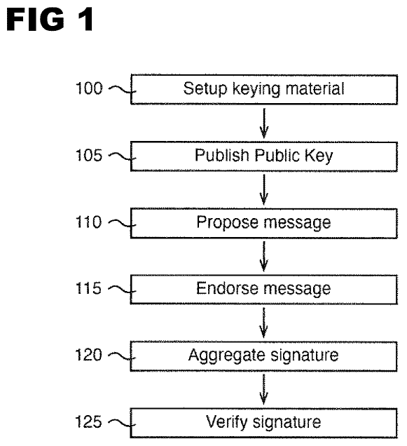

Referring to FIG. 1, shown is an exemplary flow chart of phases for generating a multiparty signature. A multiparty signature as referred to here, may be any digital signature algorithm in which some plurality of signers in a group of predetermined potential signers, may each submit individual digital signatures or perform some calculation using private keying material, these individual signatures or calculations referred to here as endorsements, which may be insufficient on their own but which, when combined with some plurality of other endorsements through some algorithm, become a valid multiparty signature. Keying material as referred to here includes any data that is generated as a result of performing calculations or manipulations on a set of inputs or random seeds, which may be used to generate a public key and digital signature. Some examples of commonly used multiparty signature algorithms include ECDSA threshold signatures, ring signatures, block certification in blockchains, and multisig wallets in cryptocurrencies.

At step 100 all of the parties who may potentially participate in a multiparty signature, referred to here as party members, coordinate to generate keying material based on the desired security level of the signature. The keying material generated, and the parameters used are dependent on the multiparty signature algorithm chosen.

At step 105 the keying material generated in step 100 is used to generate and publish a public key. A public key as referred to here is one or more public values which may be necessary to generate a digital signature or verify the validity of a digital signature. In addition to the public key, the parameters and rules for the signature may be published. For example, in a blockchain environment, the subset of party members who may submit valid endorsements for any specific block may depend on some rules and values published on the blockchain.

Publishing as described here may include any way that a party who is verifying the signature can access the required data with confidence that it has not been unduly manipulated or corrupted. This may be from a trusted or provable source, for example, through a blockchain, through a certificate authority, on a website, requested on-demand, or provided with the group signature itself. A provable source may be any trusted or untrusted source in which the public key can be proven, preferably cryptographically and potentially probabilistically, to be accurate.

At step 110, a cleartext message is proposed to party members for a multiparty signature on the message. This cleartext message may be proposed by anyone: for example, a party member, an external party, or an algorithmically generated message such as the output of a blockchain smart contract. From the cleartext message, a message digest may be generated, typically by applying a one-way function on the cleartext message. Typically, in a multiparty signature, all participating party members generate the same message digest.

It is believed in the present invention that improvements in security and efficiency are achieved if each participating party member generates a unique message digest by salting the message with an extra value, as will be understood.

At step 115, any party members who decide to endorse the message may generate an endorsement on the generated message digest. A party member who submits an endorsement will be referred to as an endorser. The method by which an endorsement is generated will vary according to the multiparty signature algorithm. In some cases, one endorser's endorsement may take as input, data from another endorser's endorsement.

At step 120, the endorsements that are generated may be aggregated and/or made available to any party. As in step 115, the aggregation of endorsements may be different depending on the multiparty signature algorithm used. The aggregated collection of endorsements will be referred to as the multiparty signature. The multiparty signature may be published as described in step 105 or delivered directly to a requesting party.

At step 125, a party may attempt to verify the validity of a multiparty signature using the public key and additional published information about the multiparty signature algorithm as described in step 105.

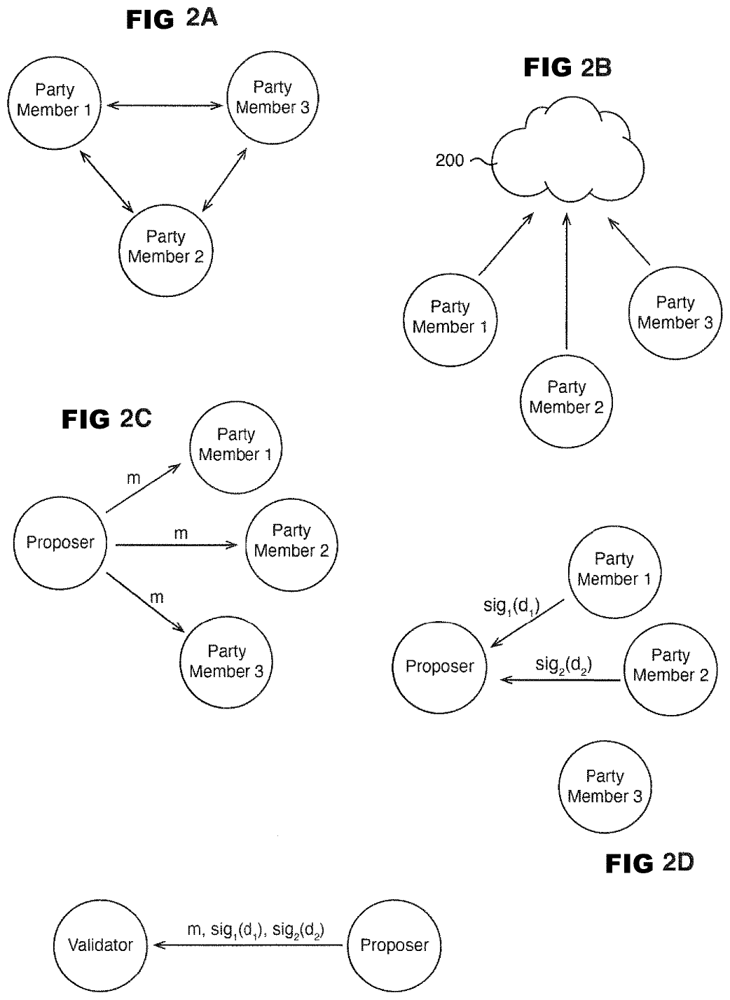

Referring now to FIG. 2A, shown is a block diagram of an exemplary way in which party members may coordinate to generate keying material for a multiparty signature as described in FIG. 1, step 100. The fact that three party members are used is not meant to limit the scope of how many party members may coordinate but is used for clarity. It will be understood by those skilled in the art that the coordination shown is done over a communication medium consisting of a fully connected graph between all party members. Party members may coordinate in many ways rather than through direct synchronous channels between each other party member such as: through a gossip protocol over a fully connected or partially connected graph, through a ring topology, or any other means where a sufficient number of party members are able to communicate.

Referring now to FIG. 2B, shown is a block diagram of an exemplary way in which party members may publish public key information for a multiparty signature as described in FIG. 1, step 105. In the present embodiment, each party member publishes the generated public key and associated information with the cloud 200 representing any of a variety of publication means as described in FIG. 1, step 105. While all party members are shown as publishing the public key and associated information, this may be performed by any subset of the party members or even by a third party. Alternatively, the information may not be published initially but provided as needed with substantial proof that it is valid.

Referring now to FIG. 2C, shown is a block diagram of an exemplary way in which a cleartext message is proposed to party members to generate endorsements as described in FIG. 1, step 110. The proposer is shown submitting a cleartext message to all party members via a direct channel. The proposer may not submit the cleartext message directly to all party members for any number of reasons so long as a sufficient subset of party members directly or indirectly receives the message in a timely manner to generate a valid multiparty signature. For example, if only two party members are required to endorse a message for a multiparty signature to be generated then the proposer may only send to two party members, one party member who can relay it to another party member, or even publish the message as described in FIG. 1, step 105. Additionally, the proposer may be a party member or an algorithm running on any machine as described in FIG. 1, step 110.

Referring now to FIG. 2D, shown is a block diagram of an exemplary way in which endorsements may be generated and aggregated as described in FIG. 1, step 110, step 115, and step 120. Two party members are shown submitting endorsements that they respectively generated on uniquely generated hash digests in an environment where two out of three party members are required to submit endorsements in order to create a multiparty signature. Uniquely generated hash digests in this context does not necessarily imply that the hash digests themselves are unique as the digest size may be of a small enough size that collisions are possible, as will be understood.

It is believed that by using uniquely generated hash digests, the security level of each endorsement may be aggregated such that the signature sizes for an endorsement for a multiparty signature with sufficient endorsement requirements may be reduced as compared to the size of a larger single signature for an endorsement with the same security level, as will be understood.

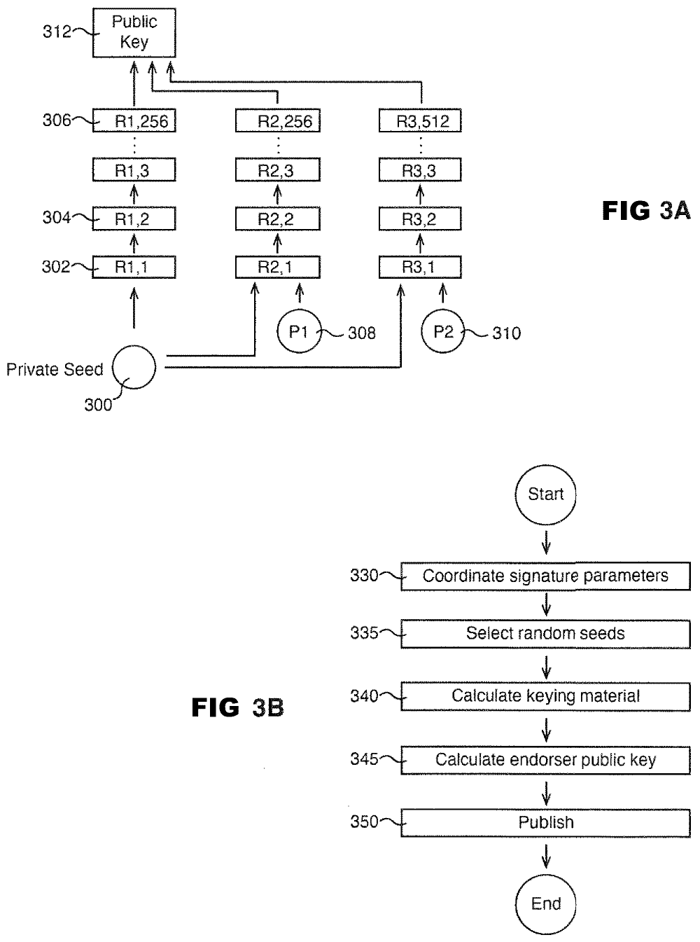

For example, in the context of a traditional hash-based one-time-use signature, the signed message digest generally should be around 32 bytes to be secure against a 2nd preimage attack on the message digest, generating a signature of about 1,000 bytes. Instead, by aggregating many smaller one-time-use signatures on uniquely generated, smaller message digests, the combined security may remain the same but each endorsement may be less than 100 bytes. While the aggregated smaller endorsements may be larger than the single larger signature in an environment where only a few signatures are required, in a multiparty signature environment where a significant number of endorsement signatures are required from a plurality of endorsers, a significant improvement is realized by using the smaller endorsements as described. An exemplary embodiment of a smaller endorsement that is insecure on its own but becomes secure in a multiparty signature environment with sufficient endorsements is described in FIG. 3A.

While each endorser sends their endorsement to the original proposer, this is only meant for clarity. Alternatively, each endorser can send their endorsement to any party or any number of different parties or publish the endorsements such that, eventually, enough endorsements may be aggregated by a party to verify if a valid multiparty signature was generated.

Referring now to FIG. 2E, shown is a block diagram of an exemplary way in which an aggregated multiparty signature may be published or shared as described in FIG. 1, step 105 and step 125. A proposer is shown communicating a cleartext message and two endorsements generated on the message to a validator. This scenario is not limiting but will be appreciated for clarity. A validator may be any party or algorithm which verifies a multiparty signature. A proposer may be any party, algorithm, or published source from which a validator may receive sufficient endorsements and associated data to verify a multiparty signature.

Referring now to FIG. 3A, shown is a block diagram of keying material for an exemplary embodiment of keying material for an endorsement of a novel hash-based multiparty signature algorithm per the teachings of the present invention and as described in FIG. 1, FIG. 2D, and FIG. 2E.

The exemplary endorsement shown is a variation of so-called hash-based one-time-signatures as introduced by Leslie Lamport and improved upon in the contemporary Winternitz-One-Time-Signature+ (WOTS+). Hash-based signatures are a group of signatures believed to be secure against quantum computing attacks as they are generated almost entirely through the use of cryptographically secure hash functions. Some examples of cryptographically-secure hash functions include SHA3 and BLAKE2. While the present embodiment is based on cryptographically secure hash functions, it is believed that any one-way function which is sufficiently difficult to invert may be used.

As in WOTS+, multiple series of values referred to here as hash ladders, are generated from a private seed. Each hash ladder is a series of rungs which are the images generated by a hash function whose preimage is the image of the rung before it. In the present embodiment, the first rung 302 in the first hash ladder is the image of a hash function with a private seed 300 as the preimage. The second rung 304 of the first hash ladder is the image after applying a hash function to the first rung 302. This process continues to the top rung 306 of the ladder.

It may be considered advantageous in certain circumstances to add additional inputs to the preimage of a rung or perform additional calculations between rungs. For example, in the present embodiment, the first rungs of the second and third hash-ladders are the images of a one-way function applied to the private seed and a cryptographic pepper P1 308 and P2 310 respectively. The cryptographic peppers shown in the embodiment may be a variety of values such as a publicly indexed salt or a randomly generated private seed so long as the generated hash-ladders are practically unique and at least one of the inputs is kept private.

As is described in the WOTS+ protocol, the number of rungs, referred to here as the height, of each hash ladder determines the size of a message digest segment each ladder can sign. The number of bits each ladder can sign is known as the Winternitz parameter and is the log₂(ladder_height). A Winternitz parameter of 8 for the first two ladders and 9 for the last ladder is shown as an example in the present embodiment equating to 2\hat{ }8=256 and 2\hat{ }9=512 rungs respectively per hash-ladder. Generally, a Winternitz value between 4 and 16 is chosen as an optimal tradeoff between signature verification time and signature size.

Once all of the hash-ladders are generated for the endorsement keying material, the top rung of each ladder is combined, for example via XOR or concatenation, and used as a pre-image in a hash function. The resulting image 312 may be used as a public key for the endorsement. It may be desired to hash this value again to generate a preimage to the public key which could be used as a hidden salt for the message digest to further increase the security of each endorsement as described in FIG. 2D.

Two types of hash ladders are shown in the present embodiment. The first two hash ladders are used to sign message digests and will be referred to as message ladders. The last hash ladder is used to sign a checksum of the message ladders. As described in the WOTS+ protocol, checksum ladders prevent an adversary from forging a published signature by hashing up one or more of the message hash ladders of a revealed signature. While the WOTS+ protocol calls for all hash ladders to have the same Winternitz parameter, it is believed to be advantageous in computing environments where communication bandwidth is particularly limited to have one or more hash ladders with a different Winternitz parameter.

As is described in the WOTS+ protocol, the number of message ladders determines how many w-bit digest segments can be signed by the signature and likewise specifies the security of the signature against second preimage attacks against the message digest. Generally, the preferred security level for hash functions is 32 bytes. A WOTS+ signature on a 32 byte digest is relatively massive, about 1,000 bytes, compared to a traditional modular exponentiation or ECC signature, generally 32 bytes of signature. In a multiparty signature setting where many endorsements are communicated in order to form a multiparty signature, these sizes may become prohibitive.

The present exemplary embodiment keying material for an endorsement of a novel hash-based multiparty signature algorithm uses a significantly smaller message digest depending on the parameters selected during setup. As shown, a two byte hash digest would be signed along with a single checksum ladder and the resulting endorsement would be 96 bytes. This endorsement is clearly insecure on its own, as it is trivial to find a second preimage on a two byte hash. However, using the teachings of the present invention as described in FIG. 2D, if one hundred endorsers, which will be understood to be a non-limiting quantity, each generate a unique digest for the same message, it is believed to be computationally infeasible for an adversary to calculate a second clear text message that would match all one hundred digests.

It is believed that an approximation of the security of an aggregated collection of endorsements against a 2nd preimage attack on the digest may be calculated with the following formula:

$$security\_level = digest\_bits \times num\_endorsements .$$

Referring now to FIG. 3B, shown is a flow chart describing the steps each party member may execute in order to generate an exemplary embodiment of a public key for a novel hash-based multiparty signature algorithm.

At step 330 the party members may coordinate amongst themselves to calculate or determine a set of parameters for the multiparty signature based on at least the level of security desired as described in FIG. 1, FIG. 2A, and FIG. 3A. Alternatively these parameters may be predetermined by a previous coordination between the potential signers or provided by another party or gathered from a published source. In the present embodiment, a novel hash-based multiparty signature algorithm is selected whose endorsement keying material was described in FIG. 3A.

At step 335 each party member may select one or more random seeds that they may use according to the established multiparty signature parameters to generate the keying material necessary to form an endorsement. Random seeds may be selected from a set of previously gathered data or generated in many ways, for example through cryptographically-secure pseudorandom number generators on a personal computer, observing random or pseudorandom phenomena, or polling published random data. Many of these random seeds may be stored in a private and secure manner such as on physical medium or on an encrypted storage device on a computer or server.

At step 340 each party member may generate keying material for the multiparty signature or an endorsement according to the parameters and protocol of the multiparty signature algorithm that has been chosen as described in FIG. 2A. The keying material may make use of any random seeds that may have been selected by the party member. The keying material may be stored in a private and secure manner or may be reconstructed as needed. An exemplary embodiment of endorsement keying material was described in FIG. 3A.

At step 345 each party member may calculate a public key for the multiparty signature. Alternatively, the construction of a public key from the generated keying material may be done by a subset of party members, or by a third party or algorithm running on a computing machine. A public key is as described in FIG. 1 step 105. The present exemplary embodiment of a public key of a novel hash-based multiparty signature may be a list of all party members' endorsement public keys along with any rules such as how many endorsements are necessary for the multiparty signature to be valid.

At step 350 a subset of party members or a third party or an algorithm running on a computing machine may publish any information or data that may be used to verify the validity of a multiparty signature generated by the party members as described in FIG. 2B. This may include, for example, an endorsement public key from each party member, the selected parameters of the group signature, or an aggregated public key from calculations performed by each signatory. In the present exemplary embodiment, the public key and the public security parameters used to generate the keying material may be published to a blockchain.

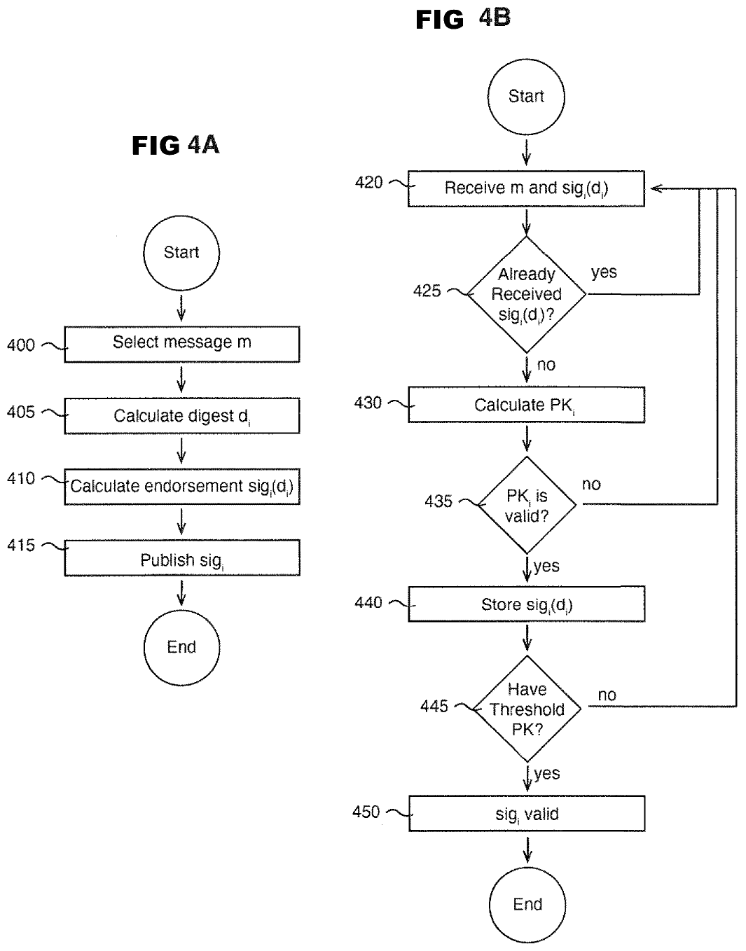

Referring now to FIG. 4A, shown is a flow chart describing a series of steps that may be used by a party member to generate an exemplary embodiment of an endorsement on a message in a novel hash-based multiparty signature algorithm.

At step 400 a cleartext message that the endorser would like to generate a group signature on is selected. The endorser may generate or receive the message in any way as described in FIG. 2C.

At step 405 a digest is generated for the message, typically in prior art by applying a hash function to the message. As described in FIG. 2D, more efficient endorsements may be achieved by including another value as an input salt to the message digest, resulting in uniquely generated digests per endorser. In the present exemplary embodiment, the endorser may combine their endorsement public key with the cleartext message via, for example, XOR or concatenation, and hash the combination to form a uniquely generated message digest. Alternatively, a secret or random value may be used instead of the endorsement public key and provided along with the endorsement. For clarity, in the present exemplary embodiment, 16 bits is the length of the message digest though it will be understood that this is an example and not a limitation.

At step 410 an endorsement is calculated on the message digest that was calculated in step 405 as described in FIG. 2D. In the present exemplary embodiment, the keying material used is as described in FIG. 3A, the peppers for the second and third hash ladders are secret random values, and the message digest is 16 bits as described in step 405. The first 8 bits of the message digest is signed by the first message hash ladder by revealing the rung at the height equal to the integer value of the 8 bit segment plus 1. For example, if the first 8 bit binary segment is 10000010 which is 130 in decimal, the endorser would reveal rung 131 in the first hash ladder. Similarly, the second hash ladder signs the second 8 bit binary segment of the hash digest. For example, if the second 8 bit binary segment is 10101010 which is 170 in decimal, the endorser would reveal rung 171 in the first second ladder. Finally, the endorser may calculate a checksum for the first two ladders by summing the revealed height of each message ladder and revealing the rung in the third hash ladder which is at: position=checksum_ladder_height−(revealed_rung_height_1+revealed_rung_height_2). In the present example, the revealed checksum rung would be 512−(131+171)=210. In the present example, the endorser's public key was used as a salt in the generation of the message digest as described in step 405. The structure of the endorsement in this example may be the message, the three revealed rungs, and the public key of the endorser.

At step 415 the endorsement is published in any way as described in FIG. 2B. In the present exemplary embodiment, for clarity, the endorsers may all send their endorsement as described in step 410 to a third party for verification. In the present exemplary embodiment any aggregated group of a sufficient number of valid endorsements from valid endorsers on message digests for the same cleartext message constitutes a valid multiparty signature on that cleartext message. For clarity, in the present embodiment, a sufficient number of valid endorsements may be 50 though it will be understood that this is an example and not a limitation.

Referring now to FIG. 4B, shown is a flow chart describing a series of steps that may be used by any party to validate an exemplary embodiment of a novel hash-based multiparty signature.

At step 420, the verifying party receives a message and endorsement. In the present exemplary embodiment, the structure of the endorsement is as described in FIG. 4A, step 415.

At step 425, the verifying party determines whether it has already received and verified the most recently received endorsement. If the verifying party has already received and verified the most recent endorsement then it throws away the endorsement and returns to step 420. If the verifying party has not yet received and verified the most recent endorsement then it moves to step 430.

At step 430, the verifying party calculates the endorsement public key from the endorsement and the message. In the present exemplary embodiment, the public key of the endorsement is included in the endorsement. The verifying party may use the included public key along with the cleartext message to regenerate the message digest for the endorsement. As described in FIG. 4A step 410, the message digest tells the verifying party what the height of each of the revealed rungs in the endorsement is. Using this information, the verifying party can hash the remaining height of each hash ladder and recreate the public key of the hash ladder from the revealed rungs. The verifying party uses this calculated public key in step 435.

At step 435, the verifying party determines if the calculated public key is valid according to the rules of the multiparty signature. In the present exemplary embodiment, if the endorsement public key that is recalculated is equal to the provided endorsement public key and it is found in the public key of the multiparty signature, then the endorsement is considered valid for that cleartext message and the verifying party moves to step 440. If the calculated endorsement public key does not match the provided endorsement public key or the public key is not in the multisig public key, then the endorsement is invalid and may be thrown away and the verifying party waits for another endorsement at step 420.

At step 440, the verifying party stores a valid endorsement and associates it with a cleartext message. Endorsements may be stored in any retrievable way until a valid threshold of endorsements is received to make a valid multiparty signature or the verifying party gives up on receiving the multiparty signature. In the present exemplary embodiment, the endorsements may be stored in a key-value database with the key being a hash of the cleartext message and the value being the list of valid endorsements received for that cleartext message. The verifying party then moves to step 445.

At step 445, the verifying party checks to see if it has enough endorsements for the cleartext message of the last verified endorsement to form a valid multiparty signature as per the rules of the multiparty signature algorithm used. In the present exemplary embodiment, as described in FIG. 4A step 415, a sufficient threshold of endorsements may be 50. If the verifying party has a list of at least 50 endorsements for a given cleartext message then the verifying party may move to step 450. Otherwise the verifying party may return to step 420 and wait for more endorsements.

At step 450, the verifying party has received enough endorsements for a valid multiparty signature on a given cleartext message. The stored endorsements may be provided to any other party along with the cleartext message to allow for further verification.

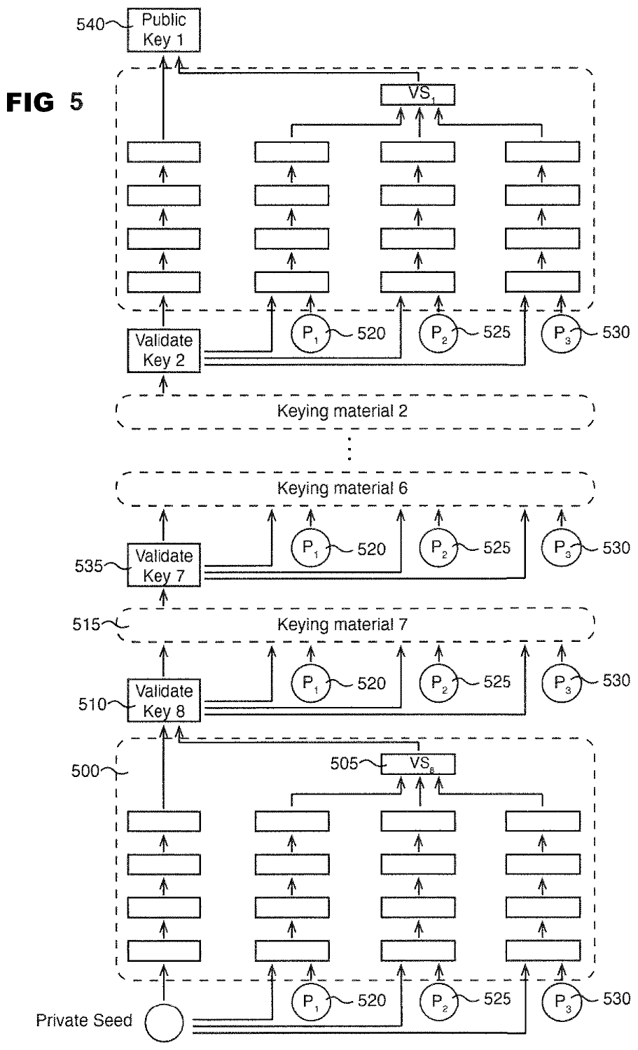

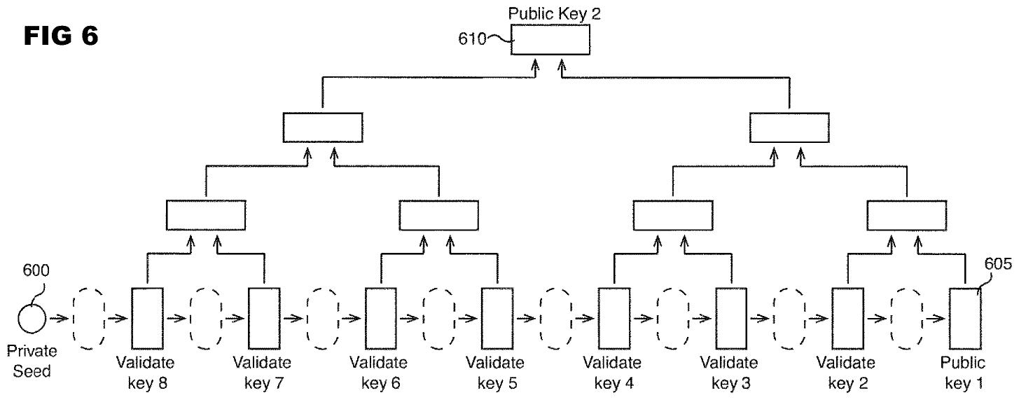

Referring now to FIG. 5, shown is a block diagram of an exemplary novel construction of a multi-use public key for a hash-based signature with multiple authentication paths. Shown is signature keying material 500 as described in FIG. 2A with an additional intermediate hash 505 called a validate salt whose preimages are the top rungs of all but the first hash ladder per keying material. Additionally, while only four hash ladders are shown for clarity, the keying material may be extended to any number of hash ladders as required and as described in FIG. 2A. While VS₈ 505 is shown as an example to enable a second authentication path, it is not a limiting requirement to having multiple authentication paths for each signature as an additional authentication path will be described in FIG. 6.

Shown at 510, what was described as an endorsement public key in FIG. 2A is now referred to as a validate key. A validate key may be described as a public key for a single hash-based signature which may be one of many validate keys all of which correspond to a single multi-use public key. In this way a validate key is able to validate a signature made using the corresponding keying material. For example, a signature using keying material 8 500 can be verified against validate key 8 510. It is believed that the preferred achievable embodiment of a multi-use public key for hash-based signatures is for a constant length public key to be capable of validating an arbitrary but predetermined number of signatures. In hash-based signatures where a public key can generally only be used once, a secondary data structure is believed to be needed to attribute multiple one-time use hash-based signature validate keys to a single, constant length multi-use public key.

In the prior art, the only known mechanism for a multi-use public key for hash-based signatures is through the use of tree structures as described in the XMSS signature protocol. In the tree-based approach, a single seed is used to generate a series of traditional hash-based signatures and the public key of each signature becomes a leaf in a tree with provable membership, like a merkle tree. The root of the tree is considered the public key and each leaf is a validate key as described. When signing a message, a single leaf of the tree-based multi-use public key is generally used to generate a traditional hash-based signature on the message. This hash-based signature can then be verified against the validate key as described in the WOTS+ protocol or in the exemplary embodiment described in FIG. 4B. An additional verification step is then required to verify the validate key corresponds with the multi-use public key. In the tree-based approach this is generally accomplished by providing a merkle proof of inclusion for the validate key in the merkle tree. This merkle proof is traditionally required along with the traditional hash-based signature to validate the signature. For a multi-use public-key with about four billion validate keys, this extra merkle proof may end up doubling the size of a traditional WOTS+ signature by adding an additional 32 hash digests to the signature size, generally resulting in an additional 1,000 bytes of data.

Shown in the present embodiment is a novel approach to generating a multi-use public key for hash-based signatures which, in some computing environments, adds only a single hash digest to the signature size and which can provide multiple authentication paths to provide the most efficient proof based on the state of the signature verifier.

It will be noticed that keying material 7 515 and validate key 7 535 are generated using validate key 8 510 and the same peppers 520, 525, and 530 rather than using a private seed. It is believed that the peppers in this embodiment should remain private and may be unique per validate key though it is believed to be more efficient from a private key storage perspective to reuse the peppers for each validate key.

By using validate key 8 as input to keying material 7, in the same way as the private seed is used to generate keying material 8, it becomes possible for another party to verify a signature using keying material 8 to validate key 7 if the party has access to the validate salt for keying material 7. It will be apparent that this is because validate key 7 uses the top rung of the first hash ladder from keying material 7 and the validate salt for keying material 7 as inputs to a hash function. The party who receives a signature using keying material 8 can trivially calculate the entire first hash ladder of keying material 7 as the only input to that hash ladder is validate key 8 which they can calculate from the signature made using keying material 8. More generally, as each validate key is used as the input for another set of keying material in this same manner, a chain may be formed of an arbitrary number of validate keys and keying materials, the last validate key being used as a public key 540. Any party who receives a signature from a validate key in the chain can authenticate it to the public key of the chain if the party has the validation salts for all validate keys between the signature it received and the public key.

It is believed that the ideal way to use this chain of validation keys is to use the last keying material in the chain, whose validation key 540 is the public key of the chain, for the first signature, with each subsequent signature using the keying material whose validation key is used as the input to the previous signature's keying material. A cryptographer skilled in the art will notice that because the first hash ladder of each prior signature is completely revealed whenever a signature is verified. Using the checksum protocol described in WOTS+ or in FIG. 2A, it is trivial to forge any previous signature upon receiving a later signature. There are at least two ways to address this issue. One exemplary method is to add another checksum hash ladder which locks the first hash ladder. This is accomplished by revealing the same height rung on the checksum ladder that is revealed in the first ladder. This of course adds an additional message digest to the size of the signature. A second exemplary method relies on an environment in which previous signatures, once verified by the environment, will no longer accept modified versions of the signature. An example of such an environment is in a distributed blockchain network where, once a signature is verified by the network and some state corresponding to that signature is committed to the blockchain, no modified version of that signature will ever be considered valid.

This chain of validation keys represents a novel multi-use public key for hash-based signatures which is believed to be particularly advantageous in environments where verifying parties reliably receive uninterrupted sequential signatures generated from the chain and where communication bandwidth is limited or a significant plurality of these signatures are being communicated, limiting the use of the tree-based approach. One such environment may be in blockchain consensus protocols where a plurality of distributed nodes is incentivized to be reliably online and frequently sending and receiving signatures confirming the state of transactions. It is believed that in such an environment, the vast majority of the time a party receives a signature, it will have already validated the previous signature to the multi-use public key, and will have the validate salt for the previous signature. In this situation, the party can quickly verify the signature against the public key by verifying it against the previous validate key without any additional information. This may be achieved by calculating the validate key for the recently received signature, calculating the top rung of the first hash ladder for the previously received signature from the calculated validate key, and hash it with the stored validate salt of the previously received signature.

Even in an environment where nodes receive most sequentially generated signatures from a multi-use public key, there may be situations where a party misses one or a couple signatures. In this situation, the party may use an alternate authentication path by requesting all validation salts between the recently received signature and the last signature verified by the public key. Alternatively, these validation salts may be published anytime a signature is generated so that they can be freely retrieved if needed. In situations where a party has missed a significant number of signatures for a multi-use public key, such as a party connecting to a network for the first time or a party going offline for an extended period of time, it may be inefficient to use the second authentication path of requesting missing validation salts. A third authentication path is presented in FIG. 6 that builds on the prior art tree approach to handle this condition.

Referring now to FIG. 6, shown is a block diagram for an exemplary embodiment of a novel multi-use public key for hash-based signatures which combines the novel signature chain approach described in FIG. 5 with the prior art tree approach as described in FIG. 5.

Shown is an exemplary chain of 8 validate keys generated from a single private seed 600 corresponding to a single public key 605 as described in FIG. 5. The peppers described in FIG. 5 have been omitted from the figure for clarity but may be used in the same way in the present embodiment. Once a multi-use public key chain has been generated as described in FIG. 5, each validate key is made into a leaf of a provable tree such as a merkle tree. The root of this tree is calculated according to the provable tree structure used and this root becomes a second public key for the multi-use signature.

By adding the tree to the chain-based approach, there are now at least three authentication paths for any node to use to verify a signature depending on their state. The first two authentication paths are as described in FIG. 5 and are most efficient when a node is substantially receiving sequential signatures from a multi-use public key and uses the first public key segment of the multi-use public key which is the last rung in the signature chain 605. The third authentication path can be provided to parties who have missed a significant number of sequential signatures, such as a party connecting to a network for the first time or a party going offline for an extended period of time, in which case a merkle proof may be provided from the validate key of the oldest received unverified signature to the second public key segment of the multi-use public key which is the root of the validate key tree 610. Once a party has used the tree-based authentication path to validate a recent signature, it may begin using the more efficient chain authentication paths for subsequent signatures.

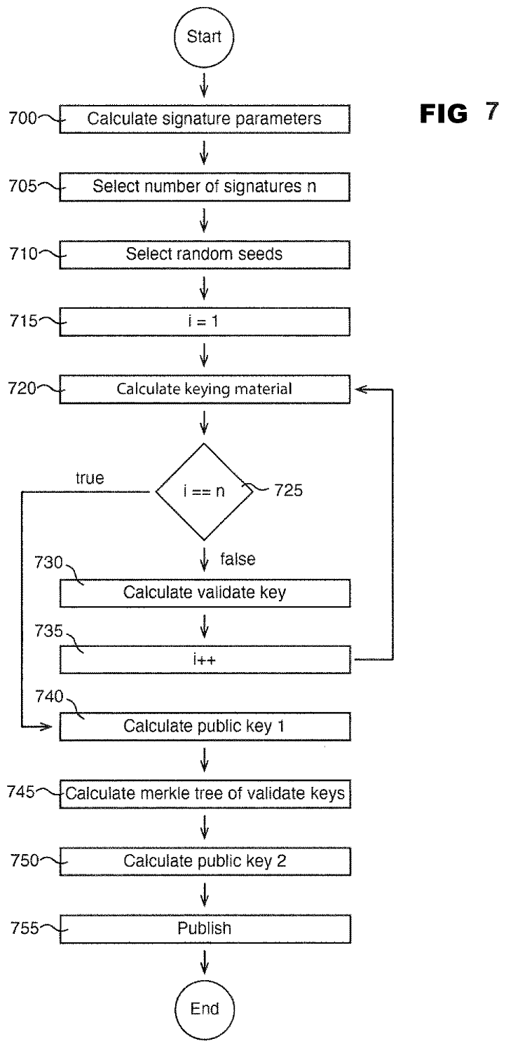

Referring now to FIG. 7, shown is a flowchart for generating an exemplary embodiment of a novel multi-use public key for hash-based signatures as described in FIG. 6, which will be appreciated for clarity.

At step 700, the party generating the public key selects the parameters for the signatures corresponding to each validation key as described in FIG. 5. These parameters generally determine the security level and size of each signature.

At step 705, the party generating the public key selects the number of signatures that can be generated from the keying material corresponding to the public key as described in FIG. 5.

At step 710, the party generating the public key selects suitably random seeds as described in FIG. 3B step 335.

At steps 715, 720, 725, 730, and 735, the party generating the public key uses the signature parameters and random seeds to iteratively generate validation keys until the selected number of validation keys is generated resulting in a signature chain as described in FIG. 5.

At step 740, the last generated validation key is used as the first segment of the public key as described in FIG. 5. It will be noted that additional computations or operations may be applied between the final validation key and the public key if desired.

At step 745, the generated validation keys are used to generate a merkle tree of validate keys as described in FIG. 6. It will be noted that a merkle tree is used as a non-limiting example and that any tree, graph, or other data structure in which inclusion in a membership may be proven may be used.

At step 750, the second public key segment is calculated from the tree or other data structure used in step 745. In the case of a merkle tree, the second segment of the public key may be the root of the merkle tree.

At step 755, the party generating the public key will publish the public key segments and any additionally required information in any manner as described in FIG. 1, step 105.

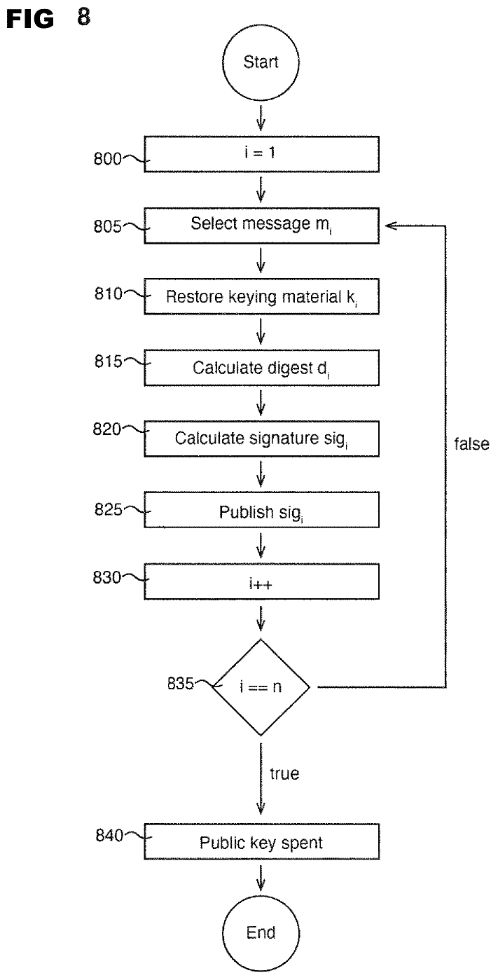

Referring now to FIG. 8, shown is a flowchart for generating a series of signatures from an exemplary embodiment of a novel multi-use public key for hash-based signatures as described in FIG. 6 and FIG. 5, which will be appreciated for clarity.

At step 800, the public key owner may initialize their state. In most hash-based signature protocols which have multi-use public keys, it is believed to be important to maintain state to prevent keying material from being reused to generate a different signature as is described in prior art. In this exemplary embodiment, the keying material is used sequentially and so it is believed to be sufficient to store the index of the last used keying material and to never reuse a used index.

At step 805, the public key owner may select a cleartext message to sign. This message may be selected in any way including as described in FIG. 4A, step 400.

At step 810, the public key owner may restore the next unused keying material in order to sign the message. Keying material may either be stored on creation or regenerated from the random seeds on-demand.

At step 815, a digest is created from the cleartext message selected in step 805. The digest may simply be generated in many ways such as a hash of the message as described in prior art or generated as described in 4A, step 405.

At step 820, a signature on the digest calculated in step 815 is calculated as described in FIG. 5.

At step 825, the generated signature is published as needed. This may be accomplished in many ways such as those described in FIG. 2B and FIG. 4A step 415.

At step 830, the used keying material state initialized in step 800 is updated to reflect that another keying material has been used and may not be used to generate further signatures.

At step 835, the public key owner checks the used keying material state that was updated in step 830 to determine if any unused keying material remains. If no keying material remains, then the public key material is spent 840 and can no longer be used to generate signatures. If additional keying material is available, then the public key owner can return to step 805 and select additional messages to sign.

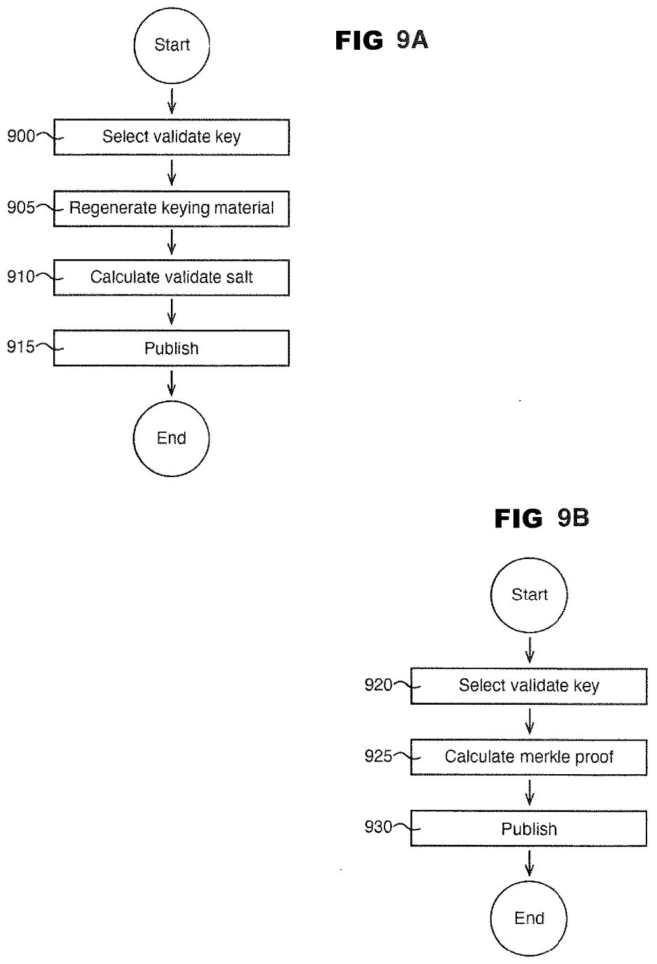

Referring now to FIG. 9A, shown is a flowchart for publishing validate salts for validate keys in an exemplary embodiment of a novel multi-use public key for hash-based signatures as described in FIG. 6 and FIG. 5, which will be appreciated for clarity. These validate salts may be requested from or needed by parties who are trying to authenticate a signature to the first public key segment but which have not received one or more published signatures between the last verified signature and signature they are trying to verify as described in FIG. 5.

At step 900, the public key owner selects the validate key for which a validate salt is needed.

At step 905, the public key owner may regenerate the keying material for the validate key selected in step 900 as described in FIG. 8 step 810.

At step 910, the public key owner calculates the salt from the keying material regenerated in step 905. Alternatively, if the keying material or the validation salt was kept in memory or storage, it may be simply retrieved.

At step 915, the validate salt may be published as described in FIG. 2B or shared with a requesting party.

Referring now to FIG. 9B, shown is a flowchart for generating merkle proofs for validate keys in an exemplary embodiment of a novel multi-use public key for hash-based signatures as described in FIG. 6 and FIG. 5, which will be appreciated for clarity. These merkle proofs may be requested from or needed by parties who are trying to authenticate a signature to the second public key segment but which have not received one or more published signatures between the last verified signature and signature they are trying to verify as described in FIG. 5 and FIG. 6.

At step 920, the public key owner selects the validate key for which a merkle proof is needed.

At step 925, a proof is generated on the validate key selected at step 920 which verifies the key to the second public key segment as described in FIG. 6. This may require regenerating the selected validate key and other validate keys in order to form a proof.

At step 915, the proof on the validate key may be published as described in FIG. 2B or shared with a requesting party.

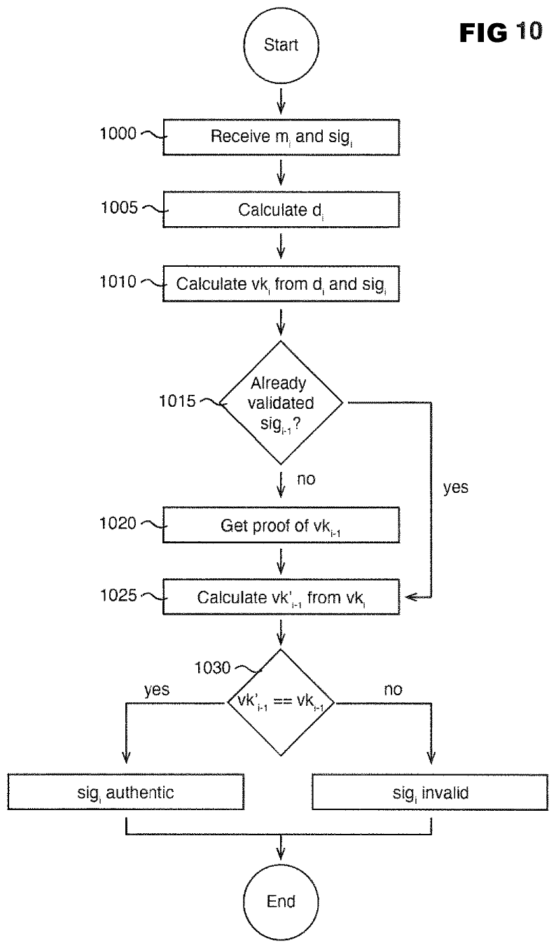

Referring now to FIG. 10, shown is a flowchart for verifying signatures in an exemplary embodiment of a novel multi-use public key for hash-based signatures as described in FIG. 6 and FIG. 5, which will be appreciated for clarity.

At step 1000, a party is trying to verify a message and a signature as described in FIGS. 5 and 6. For the party to verify the signature they should have access to published public key information as described in FIG. 7.

At step 1005, the party calculates a digest from the message using the same algorithm that the signer used as in step FIG. 8, step 815.

At step 1010, a validate key is calculated from the signature and calculated digest from step 1005, as described in FIG. 5.

At step 1015, the party checks any state that it is maintaining to determine the index of the last signature it validated from the public key it is verifying the signature against. If the party validated the previously generated signature from that public key and stored the validate salt from that previous signature, then it may move to step 1025. If it did not verify the last generated signature or it does not have the validate salt from that signature then it moves to step 1020 to get additional proof.

At step 1020, additional proof is gathered to follow an alternate authentication path as described in FIG. 5 and FIG. 6. This may be in the form of validate salts for authenticating against the first segment of the public key or in the form of inclusion proofs for authenticating against the second segment of the public key.

At step 1025, if the party is using authentication path 2, then it attempts to recreate the validate key for signature it is trying to verify. If the party is using authentication path 1, then it attempts to recalculate the validate key of the previous signature from the information it restored in step 1015 or gathered in step 1020 and the signature it is trying to validate.

At step 1030, if the party is using authentication path 2, then it compares the validate key calculated in step 1025 against the validate key it received an inclusion proof for. If the party is using authentication path 1, then it compares the calculated validate key from step 1025 with the validate key it either recovered in step 1015 or calculated in step 1025. In either case, if the validation keys being compared are the same, the signature is considered valid, otherwise it is considered invalid.

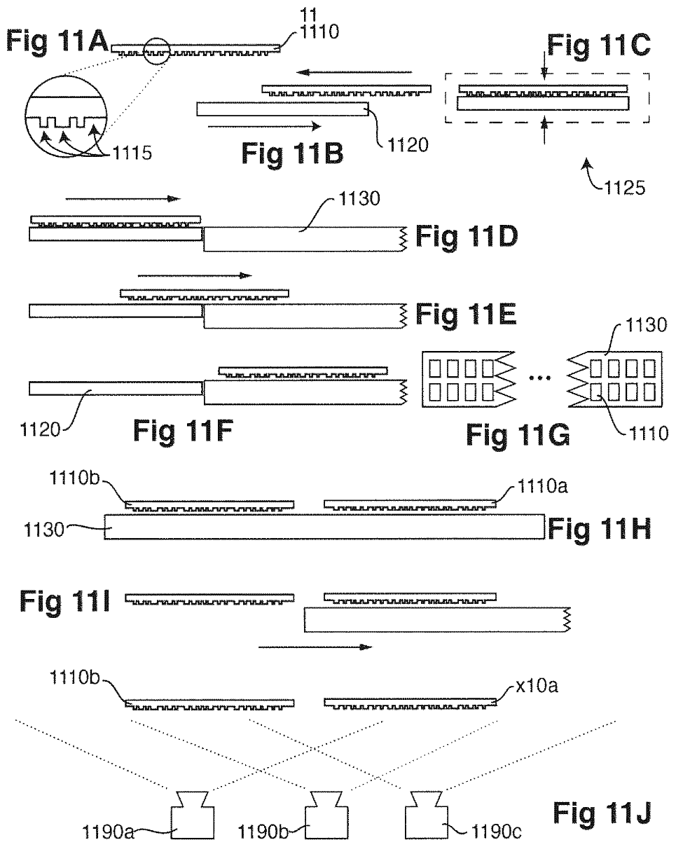

Turning now to FIG. 11A-J, exemplary detailed combination plan and section views of schematic and block diagrams for key establishment are presented in accordance with aspects of the teachings of the invention. FIG. 11A shows a substrate with indicia magnified; 11B is the hiding process; 11C is the carrier formation; 11D is the setup for the transfer from carrier to platform of an example substrate; FIG. 11E is the ongoing transfer; FIG. 11F is the completion of the transfer; FIG. 11G is a plan view (the other figures on this sheet are sections) with plural transferred substrates; 11H is multiple substrates that have been transferred onto a single platform; FIG. 11I is the ongoing configuration change of the platform from first to second configuration; and FIG. 11J is the platform in the second configuration.

Referring now more specifically first to FIG. 11A, a substrate 1110 is shown containing multiple indicia features, such as for instance barcode printing or the like, indicated as raised portion 1115 for clarity, but without limitation. The pattern of the indicia encodes at least key information and optionally additional index and/or position and/or party identification information, as will be appreciated. In some examples carriers can be placed in predefined positions, such as corresponding to party, and/or in other examples positions can be labeled and/or mainly randomly assigned. With non-assigned placement the party may or may not be determined by the indicia, as mentioned.

Referring next to FIG. 11B, substrate 1110 is shown in a process of relative movement with respect to an example hiding layer 1120.

FIG. 11C shows substrate 1110 hidden by hiding layer 1120 and the two brought into close proximity and/or contact, for instance, so that they together form what can here be called a “carrier” 1125. In some examples, a carrier can include other means, such as molded polymer housing as are known to keep two cards together or, as just another example, a box that holds the media, and/or scratch-off adhered to the media where the combination can be said here to be the carrier.

FIG. 11D shows the carrier brought into a preparatory orientation relative to what can here be called a “platform” portion 1130, the zig-zag edge of which indicating that only a portion is being shown, as will be understood.

FIG. 11E shows substrate 1110 in the ongoing process of motion relative to platform 1130, where the indicia ideally can remain verifiably hidden at least to one of an acceptably practical level or degree during this process.

FIG. 11F shows substrate 1110 positioned relative to platform 1130 so that the indicia remains hidden.

Referring now more specifically first to FIG. 11G, a larger portion of platform 1130 is shown here in plan (not section as elsewhere in this figure) view as mentioned, with plural substrates 1110 arrayed.

Referring to FIG. 11H (back now) in section view, two example substrates 1110a and 1110b are shown with indicia hidden by the exemplary portion of the platform, as indicated and will be understood.

FIG. 11I shows the ongoing motion from what may be called the

“first platform configuration” to what may here be called the “second platform configuration,” with the respective indicia transitioning from being what can here be called “hidden” to what can here be called “revealed.”

FIG. 11J shows substrate 1110a and 1110b in the second platform configuration, with their respective indicia revealed to observer persons and/or apparatus, indicated without loss of generality by sensor systems 1190a, 1190b and 1190c.

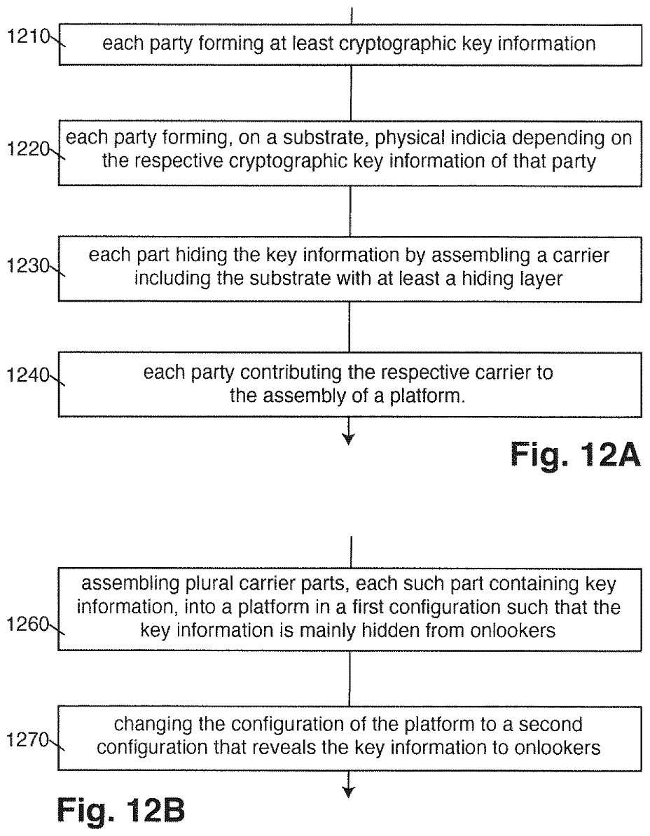

Turning now to FIG. 12AB, exemplary detailed combination flowchart and block diagrams for key establishment are presented in accordance with aspects of the teachings of the invention. FIG. 12A shows the system for creating the key indicia and 12B is the system for establishing a first and a second configuration state for a platform.

Referring now more specifically first to FIG. 12A, box 1210 is where each of plural parties forms cryptographic key information, as is known in the art. In some examples, the information can be “whitened” and/or “hashed” to produce what is used in subsequent steps, although it will be understood that after a physical reveal step additional pre-images (combined in whatever hashing or other structure) of revealed images may be released by the parties for additional hiding of the ideally but perhaps imperfectly hidden images.

Box 1220 is each party forming what can here be called a “physical instantiation” of the key information, which is any way that the key is encoded in and/or represented by physical matter or the state of such matter, including for instance electronic and/or quantum and/or printed storage technologies of whatever kind and in whatever combination, whether human and/or machine readable.

Box 1230 is where each party takes the physical instantiation from step 1220 and transforms it, by whatever means and/or method, into a form that now hides and/or mainly or is believed to strongly and/or significant and/or practically hide, the key information from observers, based on reasonable assumptions about what kinds of technology and/or sensor means the observers are able to bring to bear at what distance and for what length of capture time and length of analysis time, as will be understood.

Box 1240 is where the parties contribute their respective carrier assemblies to what will be called here the configuration of a platform in a first state. In some examples the parties each position their respective carrier relative to the platform, ideally in what may here be called a “security ceremony.” However, in some examples the platform configuration may take the carriers from the parties and/or other parties may be involved in the transfer to the platform, as will be understood.

Referring next now more specifically first to FIG. 12B, box 1260 is where the assembly of plural carriers, from box 1240 already described, are included into a platform in a first configuration, such that the key information is believed mainly and/or largely and/or securely under relevant security assumptions hidden from observers.

Step 1270 is the changing of the configuration of the platform from the first configuration state just described to the second configuration state that mainly and/or easily and/or directly reveals at least most of the key information to observers. Here the term “observers” can be used to mean any combination of people and instruments, whatever their proximity and interconnection, with purpose of obtaining the indicia and/or other information encoded in platform placement.

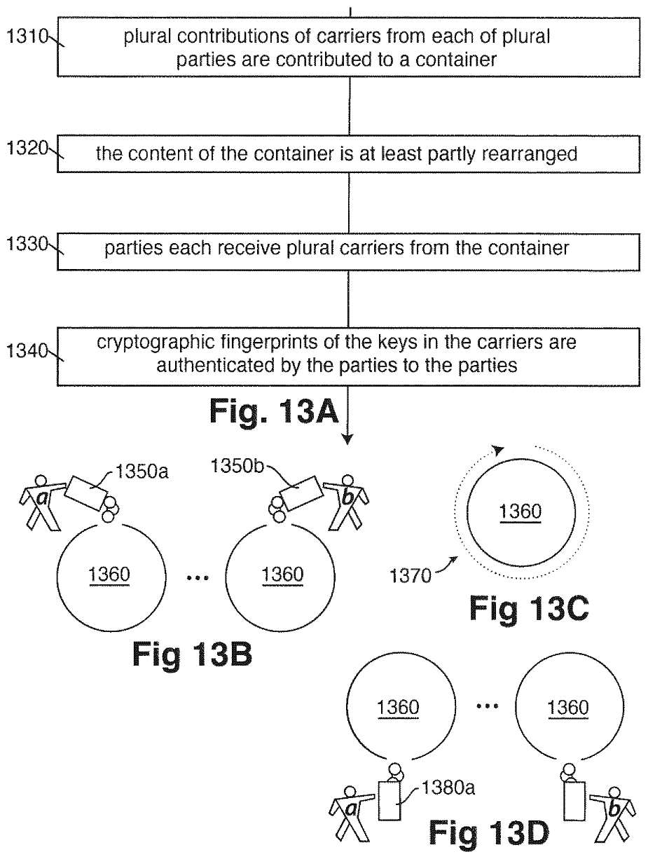

Turning now to FIG. 13, an exemplary detailed combination flowchart and block diagram for key distribution in accordance with aspects of the teachings of the invention is shown.

Box 1310 is the plural contributions of carriers, such as for instance as already described with reference to FIGS. 11 and 12, from each of plural parties. This allows each party, such as “A” and “B” shown as just two examples of potentially many, to each supply a number or otherwise measured quantity of keys that are hidden physically.

Box 1320 is the content of the container at least being partly at least what may be referred to as rearranged and/or randomized and/or tumbled and/or tossed around. A bingo hopper or a hat are common examples. This ideally hides which party will receive which carriers in 1330; however, a known and/or partly secret re-ordering is also believed to offer at least some advantages in getting carriers to different parties than those that have submitted them. For instance, an adversary may be disadvantaged by not knowing which pairs of parties did not receive keys directly and rather relied on other techniques, mentioned below, to fill those in.

Box 1330 is the distribution to the parties so that they each receive plural carriers from the container. In some examples, the number and/or other measure (for instance by volume or weight or color distribution) of how many they receive can be constrained or even held constant. It is believed, however, that when the total number is larger the differences between the number each party obtains becomes less significant.

Box 1340 is at least cryptographic fingerprints of the keys in the carriers being authenticated by the parties to the parties. Each party authenticates plural fingerprints and each such fingerprint is received as authenticated by plural parties. Typically, all parties might authenticate all the fingerprints for their respective keys in the carriers to all the other participants, such as by posting signatures on the respective fingerprints, either separately or, for instance, as a list or tree. One example way to achieve this uses the authentication keys revealed during FIG. 11 and FIG. 12 to digitally sign so-called “key fingerprints” of the keys included by the respective party in the carriers. In other examples, as will be understood, the fingerprints to be authenticated and/or images of the keys under one-way functions can be included directly in the information revealed in FIG. 11 and FIG. 12. Other means and/or methods to authenticate the keys in the carriers, in terms of from which party they originate, are known in the art and include all manner of digital authentication techniques and/or physical authentication techniques, such as for instance public key digital signatures, scratch-off, document security techniques, publishing prefixes or other portions of the keys, and so forth.

It is believed that with sufficiently many carriers contributed by each party that every party will, with an acceptably high probability, get keys for almost all the parties. These keys can be used to protect communication confidentiality and/or authenticity, as well as for the dining cryptographers protocols, among other things. There are many ways to fill in the keys for a pair of parties that wished to get a key but did not, including repeating the protocol with different parameters and/or using other key distribution techniques, such as public key and/or quantum. Another example way includes schemes where other of the parties can a pair that did not get a direct key between the pair in either direction. Each assisting party sends to the two parties of the pair parts of a replacement key. The assisting parties each send the same new part, each under cryptographic cover of the key they have with the respective one of the two parties. This lets each of the two receiving parties of the pair obtain the same secret key, by combining the parts received such as by x-or, that is then known to the two parties and only also to the set of assisting parties jointly.

What can here be called a “fingerprint” of a key is any hash and/or one-way function and/or selection of portions and/or other mathematical restriction and/or encoding of key that is believed to not mainly or wholly reveal the key or make it too easy to compute but on the other hand also serves to identify the key and, at least in some examples, for which it is believed difficult to arrive a second key for a given fingerprint and/or to arrive at two keys with a common fingerprint.

The assisting parties can provide authentication of the parts they provide to the pair, such as by signing fingerprints of the parts. The signed fingerprints can also for instance be posted.

What can hear be called a “hiding layer” can be metal (stainless steel business cards, for instance, are readily available) and/or other material. It will be understood that combining the same types of material used as the media and used to form the indicia as hiding sub-layers formed in the media and/or formed in the hiding layer may provide protection against a range of reading attacks.

We claim:

1. In a system for making a digital signature for a message where pre-defined subsets of a set of signers is sufficient and where each potential signer has pre-images that hash to a public key, the improvement comprising: each of the signers determines cleartext bits to sign in response to a hash of a pre-image known to the respective signer and the message.

2. The system of claim 1, wherein the total number of cleartext bits, summed over all signers, is chosen from the range of 100 to 1000.

3. The system according to claim 1 or 2, wherein the size of the subsets and the length of the plaintext bit strings signed is such that the number of exhaustive search attempts would be more the 2⁸⁰.

4. The system of claim 1, wherein the number of bits is at least 16 and the number of signers is a majority of at least 100 parties.

5. In a system for forming plural digital signatures using one-way functions on respective plural messages, with a common public key and a common secret seed value, the improvement comprising: two or more authentication paths per signature.

6. The system of claim 5, wherein at least one of the paths is a series authentication path.

7. The digital signature system according to claim 5 or 6, wherein at least one of the paths is a tree authentication path.

8. In a key information distribution system, the improvement comprising:
producing, for each of plural parties, respective physical media that includes respective secret key information formed as indicia; providing the respective media for each party with physical revealing means, the physical revealing means in a first physical state, so that the secret indicia is not substantially revealed to plural observers;
changing the physical configuration of the physical revealing means, after the media is received, from the first physical state to a second physical state, such that the secret indicia of substantially all the plural parties becomes known to the plural observers by the change of state.

9. The information distribution system of claim 8, some subset of the observers including parties.

10. The information distribution system according to claim 8 or 9, including that the indicia are images under substantially one-way functions and corresponding respective substantial pre-images being shown after the images are revealed by the second physical state.

11. The system of 8, wherein the images revealed in the second physical state are combined by a pre-arranged algorithm to form a value that is at least substantially infeasible for proper subsets of the parties to manipulate.

12. The system of 8, wherein the images revealed in the second physical state are combined by a pre-arranged algorithm to form a value that is at least substantially infeasible for proper subsets of the parties to determine in advance.

13. The system of 10, wherein the pre-images revealed in the second physical state are combined by a pre-arranged algorithm to form a value that is at least substantially infeasible for proper subsets of the parties to manipulate.

14. The system of 10, wherein the pre-images revealed in the second physical state are combined by a pre-arranged algorithm to form a value that is at least substantially infeasible for proper subsets of the parties to determine in advance.

15. The information distribution system of claim 8, wherein the indicia is formed on media by the respective party.

16. The information distribution system of claim 15, the party forming the indicia on the media hiding the indicia in a respective physical carrier.

17. The information distribution system of claim 16, the party forming the indicia on media providing the respective physical carrier to the physical revealing means under observation of the observers.

18. The information distribution system of claim 16, the party forming the indicia on media providing the respective physical carrier to the physical revealing means in a particular location within a framework under observation of the observers.

19. The information distribution system according to claim 8 or 18, wherein the carrier combined with the indicia combined with the placement in the framework reveals to observers an identity of the party.

20. The information distribution system of claim 8, wherein the indicia are printed on cards and the cards are protected by substantially opaque cards layered on the card at least until they are transferred to the physical revealing means and the cards and the opaque cards are held together by a physical carrier means and the physical revealing means comprising a framework for holding carriers without the hiding means.

21. In a key distribution system, the improvement comprising:
forming secret keys for respective plural parties as indicia hidden from observers by respective carriers;
plural contributions of carriers for each of the plural parties contributed to a container;
the content of the container at least partly rearranged;
parties each receiving plural carriers from the container after the at least partial rearrangement; and
provision of authentication by the respective parties of fingerprints of the keys that were contained in the carriers contributed by the respective parties.

22. The key distribution system of claim 20, further comprising cryptographic authentication by keys revealed by each party that are associated with that respective party.

23. The key distribution system of claim 22, including authentication by keys revealed by each party in person to other parties while observed by observers.

24. The key distribution system of claim 21, the content of the container at least partly rearranged by physically changing an orientation of the container under observation of observers

25. The key distribution system according to claims 23 and 24, including the parties as at least some of the observers.

26. The key distribution system of claim 21, including the at least partly rearranging substantially hiding from at least some observers correspondence between the party corresponding to at least a carrier contributed and the party receiving that carrier.

27. The key distribution system of claim 21, including a set of parties allowing a pair of parties that did not receive a common key to develop a common key by each of the set of parties providing the same secret to both members of the pair of parties.

28. The key distribution system of claim 27, at least some of the allowing set of parties providing to the pair of parties authentication of fingerprints of the key provided that pair.

29. The key distribution system of claim 21, including forming of the carriers by the respective parties forming the indicia on a media layer and including additionally a substantially hiding layer.

30. The key distribution system of claim 29, wherein the carrier forming includes at least one party applying a scratch-off layer to the respective indicia bearing portion of the media as at least part of the hiding layer.

1-30. (canceled)

31. In a system for forming plural digital signatures using one-way functions on respective plural messages, with a common public key and a common secret seed value, the improvement comprising:
two or more authentication paths per signature.

32. The system of claim 31, wherein at least one of the paths is a series authentication path.

33. The digital signature system according to claim 31, wherein at least one of the paths is a tree authentication path.

34. The digital signature system according to claim 32, wherein at least one of the paths is a tree authentication path.
